(19) United States
(12) Patent Application Publication
(10) Pub. No.: US 2025/0245534 A1
(43) Pub. Date: Jul. 31, 2025

(54) METHOD AND APPARATUS FOR ALGORITHM TUNING BASED ON MACHINE LEARNING AND OPTIMIZATION

(71) Applicant: AT&T Intellectual Property I, L.P., Atlanta, GA (US)

(72) Inventors: Vladimir Sevastyanov, Fort Worth, TX (US); Abhay Dabholkar, Allen, TX (US); Rahki Gupta, Frisco, TX (US)

(73) Assignee: AT&T Intellectual Property I, L.P., Atlanta, GA (US)

(21) Appl. No.: 18/427,159

(22) Filed: Jan. 30, 2024

(51) Int. Cl. G06N 7/01

(52) U.S. Cl. CPC G06N 7/01

(57) ABSTRACT

Aspects of the subject disclosure may include, for example, designing of a numerical experiment for tuned parameters and external parameters for a parametrized algorithm; calculating Key Performance Indicators (KPIs) for the parametrized algorithm for each combination of the tuned parameters and the external parameters; generating regression models based on the tuned parameters and the external parameters for each of the KPIs; optimizing the regression models with constant external parameters values and determining optimal values of the tuned parameters; and executing the parametrized algorithm with the optimal values of the tuned parameters. Other embodiments are disclosed.

### FIELD OF THE DISCLOSURE

The subject disclosure relates to a method and apparatus for algorithm tuning based on machine learning and optimization.

### BACKGROUND

The vehicle routing problem (VRP) is a challenging problem with high practical value that has been extensively studied by the artificial intelligence and operations research communities. One trend in solving VRPs is the shift toward more generic and robust route optimization algorithms. However, optimization models and algorithms are still typically hand-tuned by experts on a case-by-case basis. The need for an expert in this process creates a barrier for the widespread use of the latest scientific advances to solve real-life optimization problems. Particularly, absence of such experts forces algorithm users to avoid algorithm tuning and use default parameter values for any use cases, and any VRP scenarios. Such a simplistic approach significantly reduces efficiency of VPR algorithms, and in turn, reduces business efficiency.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A depicts an illustrative embodiment of a method in accordance with various aspects described herein including planning an experimental design and performing a numerical experiment with a model.

FIG. 2B depicts an illustrative embodiment of a portion of an experimental design table generated by a Sobol sequence generator.

FIG. 2C depicts an illustrative embodiment of a portion of numerical experiment results with calculated KPI values.

FIG. 2D depicts an illustrative embodiment of a method in accordance with various aspects described herein including building regression models.

FIG. 2E illustrates a Pareto frontier in accordance with various aspects described herein.

FIG. 2F depicts an illustrative embodiment of a GUI in accordance with various aspects described herein including an interactive application for performing multi-objective optimization and selecting the best model tuning parameters manually.

FIG. 2G illustrates results of a single-objective constrained optimization in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for tuning (e.g., automatically) multiparametric algorithms, such as tuning of algorithms for vehicle routing problems. As an example, the method and apparatus can include one or more of: (a) splitting algorithm parameters into two groups: internal (tuned) and external parameters such as location, demand-supply parameters, which allows for a generalized approximating model that can be reused for all (or selected) use cases; (b) tuning of categorical and numerical algorithm parameters; (c) using several key performance indicators (KPI) for multi-objective optimization of the tuned parameters; and (d) using several KPIs for constrained single objective optimization. In one or more embodiments, the utilization of light approximating models instead of heavy tuned algorithms improves computational efficiency.

In one or more embodiments, to build more flexible academic and commercial solvers for routing problems, hand-tuning of algorithms can be automated or semi-automated. As an example, the search of the right optimization parameters can be automated. As another example, a model-based approach can be employed, which includes running an algorithm (e.g., VPR) for different algorithm parameters values, building a model for estimated KPI values that covers all (or selected) use cases, and optimizing (or improving) the model to determine optimally (or improved) tuned algorithm parameters for any given use case, such as for a VPR algorithm. As another example, generic models can be built or otherwise generated, which can be reused many times with variable demand and supply parameters changing every day. This allows avoiding implementing a time-consuming model building process on a daily basis.

The method and apparatus described herein can be utilized with other parametrized algorithms which can be tuned. Other embodiments are described in the subject disclosure.

One or more aspects of the subject disclosure include a method comprising: designing of a numerical experiment, by a processing system including a processor, for tuned parameters and external parameters for a parametrized algorithm; calculating, by the processing system, KPIs for the parametrized algorithm for each combination of the tuned parameters and the external parameters; generating, by the processing system, regression models based on the tuned parameters and the external parameters for each of the KPIs; optimizing, by the processing system, the regression models with constant external parameters values and determining optimal values of the tuned parameters; and executing, by the processing system, the parametrized algorithm with the optimal values of the tuned parameters.

One or more aspects of the subject disclosure include a device, comprising: a processing system including a processor; and a memory that stores executable instructions that, when executed by the processing system, facilitate performance of operations, the operations comprising: obtaining values, constraints and tuned parameters from an external source that are associated with an algorithm; access KPI regression models associated with at least one of the parameters; generate Uniformly Distributed Sequence (UDS) points within a range for the tuned parameters; calculate KPI values utilizing the KPI regression models and the UDS points; filter the KPI values based on the constraints to generate filtered KPI values; select particular tuned parameters from a point from among the filtered KPI values; and execute the algorithm utilizing the particular tuned parameters.

One or more aspects of the subject disclosure include a non-transitory machine-readable medium, comprising executable instructions that, when executed by a processing system including a processor, facilitate performance of operations, the operations comprising: providing a Graphical User Interface (GUI) at a display that includes icons for selecting values that are associated with a tunable algorithm and for selecting one or more constraints for one or more objectives; executing a Monte Carlo algorithm based on the values and responsive to movement of one or more of the icons resulting in generated values; applying a Pareto filter to the generated values resulting in filtered values; applying the one or more constraints for the one or more objectives to the filtered values resulting in tuned values; and executing the tunable algorithm utilizing the tuned values.

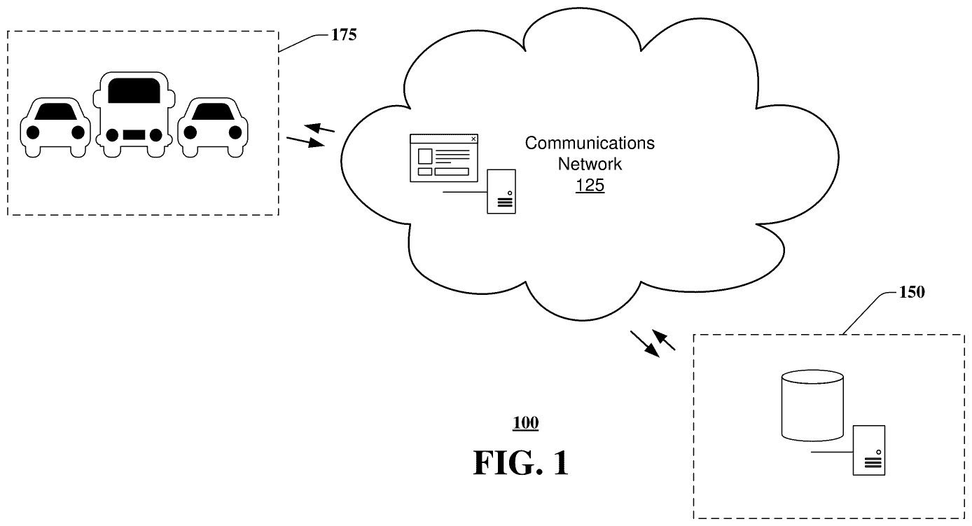

Referring now to FIG. 1, a block diagram is shown illustrating an example, non-limiting embodiment of a system 100 in accordance with various aspects described herein. For example, system 100 can facilitate in whole or in part optimizing or improving various algorithms (e.g., VPR) such as through tuning of parameters. For instance, a communications network 125 can provide communication services to various devices or equipment, such as a server(s) 150 (which can include or otherwise have access to one or more databases or storage systems) and computing devices 175 which can be end user devices (e.g., technician end user devices, technician vehicle computing systems, mobile devices, or other types of computing devices which may or may not be associated with technicians). In one or more embodiments, the server 150 can be part of an enterprise, service provider or other entity that employs algorithms such as for managing business services.

In one embodiment, the server 150 can tune parametrized algorithms such as vehicle routing problem solvers to improve several KPIs that are significant to a business. In this example, the VPR algorithm can provide optimized or improved routes to the end user devices 175, such as technicians that need to visit various job sites of customers. It should be understood that the VPR algorithm can be applied to various industries and it should be further understood that some or all of the functions and components described herein can be applied to tuning of various algorithms, including multiparametric algorithms. Tuning of parametrized algorithms can be important to several industries, and there can be different approaches to solving it.

In one or more embodiments, tuning of parametrized algorithms is provided that can be an improvement over utilizing a single objective function to optimize configuration tuning, which would be a single KPI or a linear combination of several KPIs.

In one or more embodiments, a model-based technique can be utilized, which can include one or more of: (a) design of experiment (DOE) as a uniformly distributed sequence over tuned parameters' space; (b) running VPR algorithm multiple times according to the DOE plan and calculating all KPIs which need to be improved; (c) building a regression model for each KPI; and (d) optimizing the model to determine optimally tuned VPR algorithm parameters for any given use case.

In one or more embodiments, tuned VPR algorithms to optimize routes for each technician can be an important part of a business. In one or more embodiments, rather than a particular algorithm using the same default parameter values for each location and each day, tuned parameters can be employed. For example, tuning of the VRP algorithm parameters can improve its efficiency and improve such KPIs as miles per dispatch and jobs per technician by 10-20%. Optimal tuning is different every day even for the same location because demand-supply parameters are different from day to day. In one or more embodiments, the method and apparatus described herein allows building approximating models for a variety of conditions covering all (or selected) use cases and locations. This allows the reuse of the model many times, which can find optimal tuned parameters every day despite variable business conditions.

Communications network 125 can provide various services such as broadband access to a plurality of data terminals via access terminals, wireless access to a plurality of mobile devices and vehicles via base stations or access points, voice access to a plurality of telephony devices, via switching devices and/or media access to a plurality of audio/video display devices via media terminals. In addition, communication network 125 can be coupled to one or more content sources of audio, video, graphics, text and/or other media. Broadband access, wireless access, voice access and media access can be provided separately or combined to provide multiple access services to a single client device (e.g., mobile devices can receive media content via media terminals, data terminals can be provided voice access via switching devices, and so on).

The communications network 125 includes a plurality of network elements for facilitating the broadband access, wireless access, voice access, media access and/or the distribution of content from content sources. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the base stations or access points can include a 4G, 5G, or higher generation base station, an access point that operates via an 802.11 standard such as 802.11n, 802.11ac or other wireless access terminal. The mobile devices can include mobile phones, e-readers, tablets, phablets, wireless modems, and/or other mobile computing devices.

In various embodiments, the communications network 125 can include wired, optical and/or wireless links and the network elements can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In one or more embodiments, the efficiency of optimization algorithms (e.g., VRP algorithms) can be improved by involving or otherwise utilizing Design Of Experiments, regression analysis to build a model reflecting performance landscape, and Monte Carlo optimization algorithm to tune the optimization algorithm parameters.

In one or more embodiments, solution spaces may be irregular, mainly due to the presence of categorical parameters. In one or more embodiments, a solution can be optimized on multiple objectives, which can be difficult to express the quality of a solution in a single value.

The VRP is a combinatorial optimization and integer programming problem which asks “What is the optimal set of routes for a fleet of vehicles to traverse in order to deliver to a given set of customers?” Input parameters can include location id, jobs count, and technicians' count. Location id is linked to a particular geographical area where the VRP algorithm is supposed to find optimal routes for each technician. Technician count represents the number of available technicians for the current date which are expected to serve the number of customers represented by parameter jobs count.

Since one or more of the embodiments are dealing with tuning of VRP algorithm parameters, the VPR algorithm can be considered as a black box:

$$K = F ( C , X ) \qquad ( 1 )$$

F is a VRP optimization algorithm. X is a vector of the VPR algorithm parameters which can be tuned to optimize K; X is vector of internal parameters of the algorithm. C is a vector of input parameters which represent location and supply-demand parameters; such parameters have given values and cannot be tuned, thus parameters C are considered to be external for the VRP algorithm. K is a vector of Key Performance Indicators (KPI) such as average miles per dispatch (mpd), average jobs per technician (jpt), count of high priority jobs not assigned to a technician for a given day and given location id, etc.

Tuning of VRP algorithm parameters is to be performed for each location which has its own parameters such as location id, job count and technician count. On the other hand, model (1) can cover the entire country or other large region. Therefore, a location related model parameter C can be introduced.

Since it is desired to optimize multiple KPIs, each KPI is to be represented by a separate equation, and tuning of the VRP algorithm is formulated or otherwise addressed as a multi-objective optimization problem:

$${min}_{x ∈ X} \{ {f}_{1} ( C , X ) , {f}_{2} ( C , X ) , … , {f}_{n} ( C , X ) \} \qquad ( 2 )$$

Direct optimization of the model (1) is not practical because each model evaluation takes dozens of minutes and even hours, and it is required to spend hundreds of evaluations to tune that model for a single day at a single location and further that there are thousands of locations covering this particular region (e.g., the United States). In order to reduce the cost of the tuning computational process, a model-based approach can be implemented, which allows substitution of the computationally expensive model (1) by a light model (3):

$$K = \hat{F} ( C , X ) \qquad ( 3 )$$

\hat{F} is an approximating model for the equation (1).

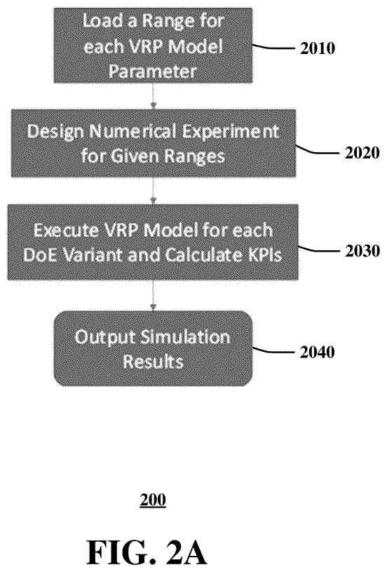

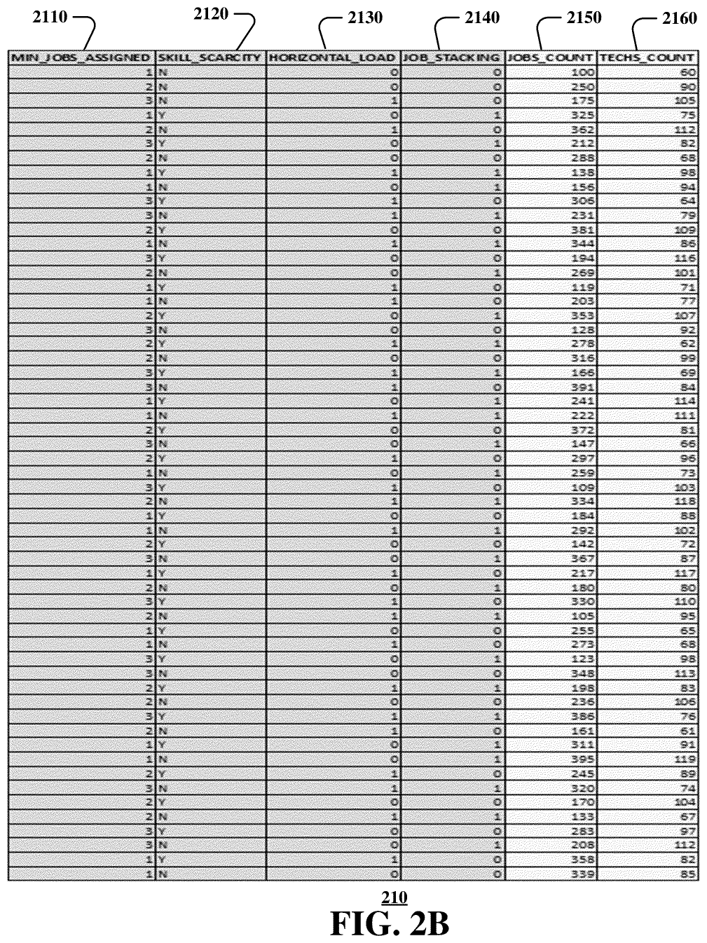

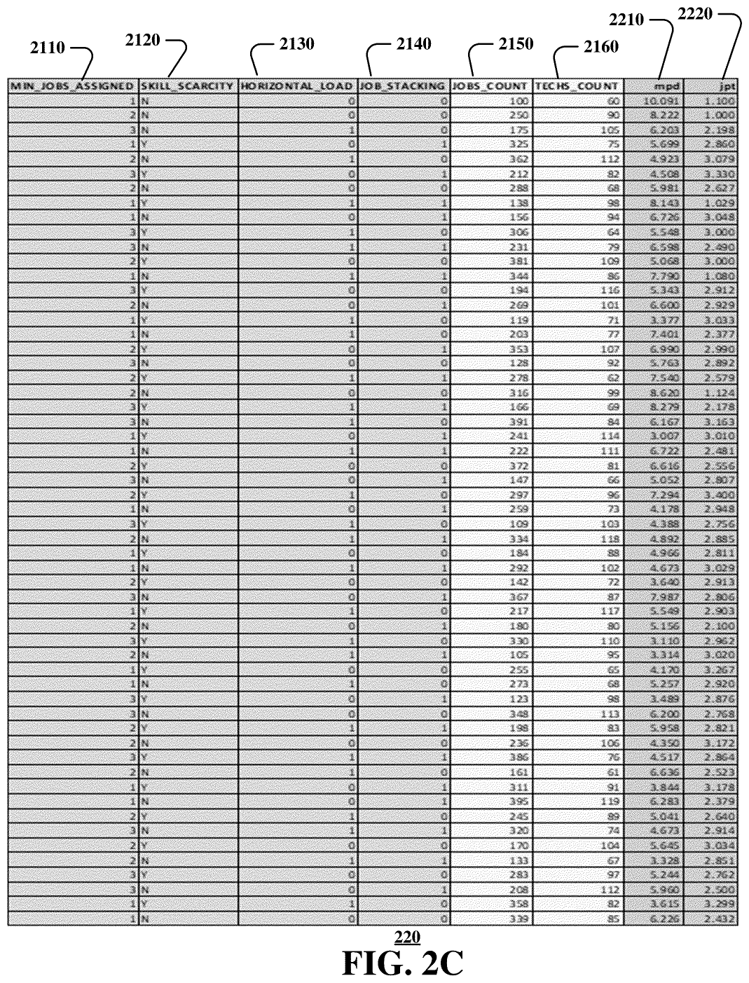

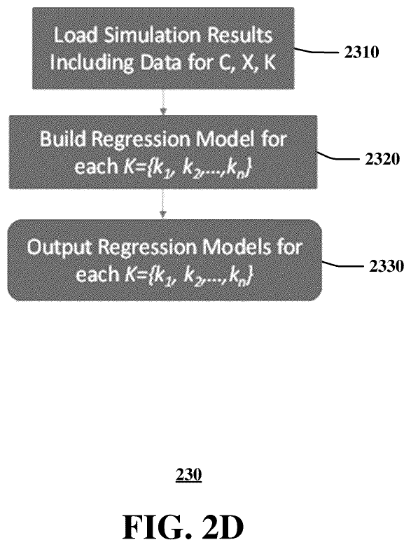

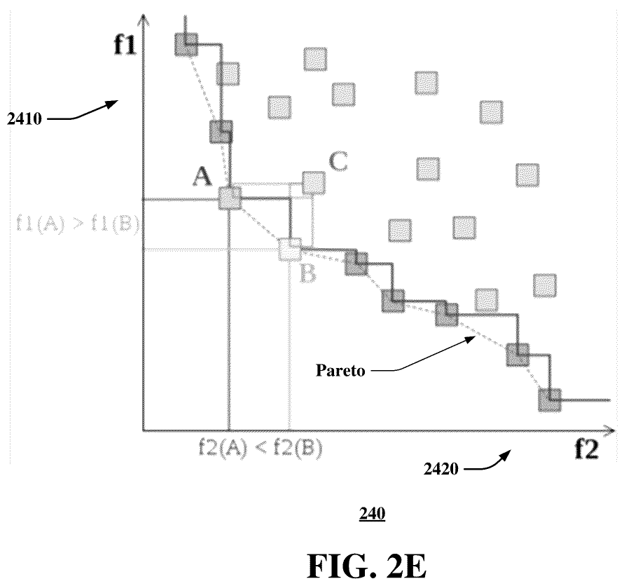

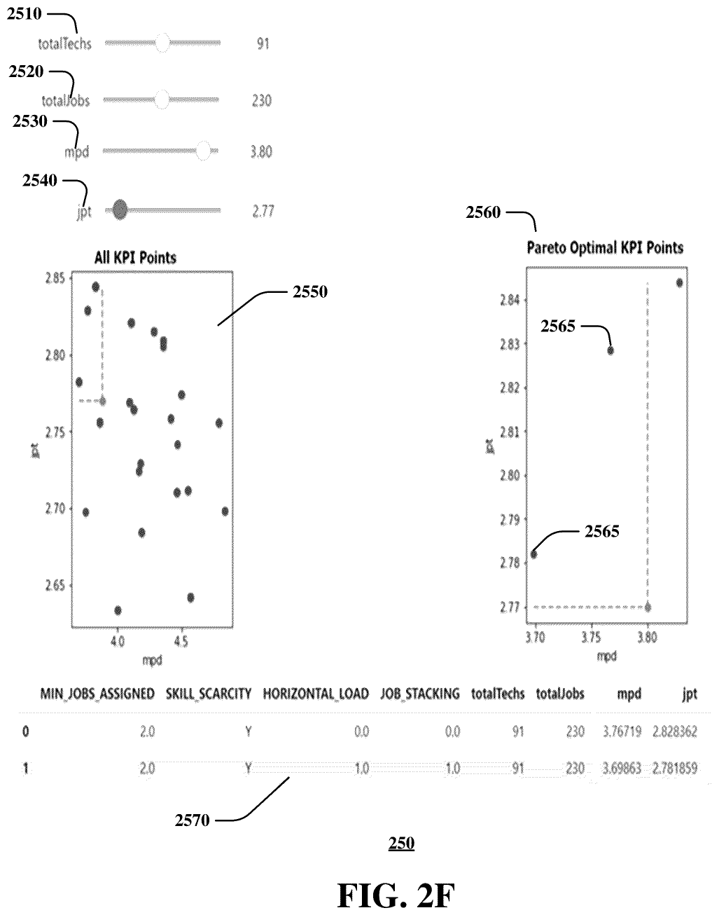

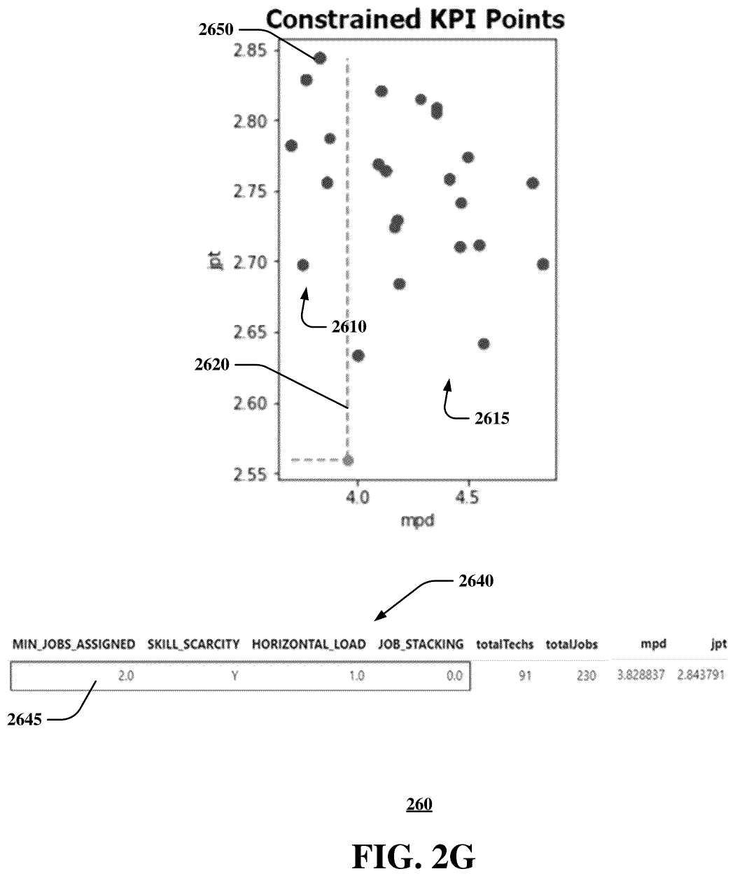

The approximation of model (3) can be built through use of a series of steps which include Design of Experiments. As an example and referring to method 200 of FIG. 2A, parameters C, X can be used where the two parameters are united: P=C∪X. For instance, vector P can have the following types of projections: numerical, binary, logical and categorical. The domain related to the vector P can be determined, which includes a range for each projection. For numerical parameters the range is determined by minimum and maximum values. For categorical parameters the range is determined by complete list of unique categorical values. For binary parameters the range is determined by two possible values: {0;1}. For logical parameters the range is determined by two possible values: {true; false}.

In one or more embodiments, DOE can be employed which is a systematic method that enables studying the relationship between multiple input variables and key output variables. It is a structured approach for collecting data and making discoveries. The purpose of DOE can be performing numerical experiments with a VRP algorithm, calculating KPI values K, and building regression models (3) for each KPI variable:

$$K = \{ {k}_{1} , {k}_{2} , … , {k}_{n} \} , where {k}_{i} = {f}_{i} ( P ) , i = 1 , … , n \qquad ( 4 )$$

Since there is no information about significance of each factor included in the vector P, and a lack of knowledge as to what kind of regression formula is the most appropriate for any of kᵢ=ƒᵢ(P), DOE methods cannot be selected based on an assumption about a particular type of regression model such as linear, quadratic, exponential, logarithmic, and so forth.

In one or more embodiments, the selected DOE method can be Uniformly Distributed Sequence (UDS) because it can cover a domain uniformly and can put any type of models-candidates in equal conditions. In other embodiments, different DOE algorithms can be used including when performing automatic tuning of other types of algorithms.

Various types of UDS exist. For instance, if you take the fractional parts of the set of numbers {n cos(nx):integer n>0}, the result is uniformly distributed for almost all x. Pseudo-random numbers generated by any random number generator are also uniformly distributed. Also, there are quasi-random number generators such as Sobol sequence. In one embodiment, a Sobol sequence can be utilized rather than pseudo-random numbers, since the Sobol sequence covers the space more evenly.

An example is illustrated in part by the data tables 210 of FIG. 2B which is associated with a particular multiparameter VRP algorithm that can be tuned, such as one that has four parameters. For instance, the parameters can have the following ranges: MIN_JOB_ASSIGNED has range {1, 2, 3} at 2110; SKILL_SCARCITY has two possible values: {Y, N} at 2120; HORIZONTAL_LOAD has two possible values: {0, 1}at 2130; and JOB_STACKING has two possible values: {0, 1} at 2140. Parameters 2150 and 2160 represent supply-demand parameters in ranges taken from historical data, which can be used to generalize the regression models, and make them applicable for any combination of JOBS_COUNT (demand) and TECHS_COUNT (supply) parameters: JOBS_COUNT has range [100; 400]; and TECHS_COUNT has range [60; 120].

Referring back to FIG. 2A, at 2010 all the above ranges can be loaded. At 2020, a Sobol algorithm can generate uniformly distributed points in the above ranges as illustrated by data table 210 (only the first 58 out of 256 points is illustrated).

At 2030, a numerical experiment can be performed with the available VRP algorithm. For example, it can be executed for each of 256 lines in the data table 210. Two KPIs can be calculated for each numerical experiment: mpd (miles per dispatch) 2210 and jpt (jobs per technician) 2220 as illustrated in data table 220 of FIG. 2C.

Referring additionally to method 230 of FIG. 2D, in order to build regression models, simulation results can be loaded at 2310. At 2320, a regression model can be built or otherwise generated at 2320 for each KPI variable based on equation (4). At 2330, the regression models can be output for each KPI.

Each KPI variable (2210, 2220) depends on the input variables P (2110, 2120, 2130, 2140, 2150, 2160). The first four variables (2110, 2120, 2130, 2140) are categorical, and the two others variables (2150, 2160) are numerical. In one embodiment, one-hot encoding can be utilized to transform categorical input variables into a numerical format, and then a regression analysis algorithm can be applied. For example, it was found that for data table 220, the best models had RSQ=0.4 and below, which may have been caused by a high non-linearity of the dependencies that are to be approximated.

In one embodiment, a boosting algorithm can be utilized (e.g., xgboost python), and a hyper parameter grid search can be applied such as with multiple (e.g., 5) folders cross-validation at each iteration. Hyperparameter tuning can be utilized for controlling the behavior of a machine learning model. By correctly tuning the hyperparameters, the estimated model parameters can avoid producing suboptimal results which fail to minimize the loss function and which would result in the model making more errors. In an example, the models used for the data table 220 have RSQ=0.64 for mpd, and RSQ=0.85 for jpt. This level of accuracy allows using such models for tuning the VRP algorithm.

In one or more embodiments, the VRP algorithm and tuning of its parameters can be launched according to a particular schedule, such as every night, to calculate optimal routes for all technicians (e.g., for the next day). However, the number of technicians and the number of jobs are variable from day to day, which impacts tuning results and makes previous tuning invalid or otherwise inaccurate. One or more of the exemplary embodiments, avoid building regression models every day since that would be a heavy resource consuming task. In one or more embodiments, demand-supply parameters are included in the model in order to generalize the models. The values of JOBS_COUNT 2150 and TECHS_COUNT 2160 are evenly distributed over their ranges. In one or more embodiments, the regression models can be reused for any combination of the demand-supply variables.

In one or more embodiments, multi-objective optimization and manual tuning can be performed, such as of a VRP algorithm. For example, algorithm tuning with two KPIs such as mpd and jpt can be performed. The purpose of a VRP algorithm is to find an optimal route for each technician. Optimal routes generally have a relatively small distance from a current point to a customer address for each technician, and an average number of miles per dispatch should be small. However, tuning of the VRP parameters can reduce the final mpd value. If the mpd is reduced, then the technician spends less time for driving and more time working at the job site. Therefore, average number of jobs per technician jpt should be increased.

It is clear from the above considerations that mpd should be reduced or minimized, and jpt should be increased or maximized, which can be addressed as a multi-objective optimization task formulated in equation (2).

It is generally not possible to find a single optimal solution for multi-objective optimization problem because the objective functions are typically in contradiction to each other: if ƒ₁(P) is improved then ƒ₂(P) gets worse, and vice versa. In one or more embodiments, the solution can include several points named Pareto optimal points, or a Pareto frontier. FIG. 2E illustrates a graphical example 240 of a Pareto frontier with objectives 2410 and 2420. The boxed points represent feasible choices, and smaller values are preferred to larger ones. Point C is not on the Pareto frontier because it is dominated by both point A and point B. Points A and B are not strictly dominated by any other, and hence lie on the Pareto frontier.

A multi-objective optimization task can be formulated for objective functions [symbol] (C, X) and [symbol] (C, X). Approximating regression models functions [symbol] (C, X) and [symbol] (C, X) can be built or generated on an extended set of input parameters: X={MIN_JOBS_ASSIGNED, SKILL_SCARCITY, HORIZONTAL_LOAD, JOB_STACKING}—VRP algorithm tuning parameters.

Parameters C={totalTechs, totalJobs} make models for mpd and jpt more generic. These parameters are responsible for job loading. The number of technicians and the number of jobs can be different every day and can become available only a few hours before the beginning of a day. Particular values for totalTechs and totalJobs can be entered, allowing for solving the optimization task, resulting in tuned VRP parameters being identified for the current date. In one or more embodiments, the same regression models [symbol] (C, X) and [symbol] (C, X) can be used any number of times.

The optimization task formulation for this example is:

$${C}_{1} = {C}_{1}^{*} ; {C}_{2} = {C}_{2}^{*} \qquad ( 5 )$$

$${minimize}_{x ∈ X} ( C , X )$$

$${maximize}_{x ∈ X} ( C , X )$$

Since variables X are categorical, the optimization domain is very structured, such that gradient-based optimization algorithms should not be used. In one or more embodiments, a Monte Carlo optimization algorithm is used instead. In this example, the number of possible combinations of parameters X is very small: 2×2×2×3=24. To find Pareto optimal points in this particular case, output values are calculated for both regression models of 24 points.

In this example, there are two objectives and four tuned VRP parameters, which would not require Monte Carlo optimization, such that both objectives can be calculated on the 24 points directly. In other embodiments, the number of possible combinations for categorical variables can be very large, and the number of objectives can be very large, where the use of Monte Carlo optimization should be used.

Referring to FIG. 2F, a GUI 250 is illustrated that allows for an interactive (manual) way to solve the optimization task of equation (5) and find the best tuned parameters for the VRP algorithm. The interactive application that provides GUI 250 allows a user to enter values 2510 of available technicians (for the particular date) and a number of jobs 2520. GUI 250 further allows setting worst acceptable values (e.g., constraints) for objective functions, selecting best setting variant for the VRP algorithm, submitting it to the VRP algorithm, initiating execution of the algorithm, and obtaining optimal routes for each technician output by the VRP algorithm.

For example, a user can move slider 2510 to set totalTech to “91”; and can move slider 2520 to set totalJobs to “230.” In one embodiment, slider movement can trigger execution of Monte Carlo code which generates for this example 24 values for mpd and jpt models, which is illustrated in plot 2550.

A Pareto filter can be applied to the generated values, which results in an output of only three Pareto optimal points on the plot 2560. A user can move slider 2530 to set a worst acceptable value for the objective mpd to “3.80” and can move slider 2540 to set a worst acceptable value for the objective jpt “2.77”; resulting in the dashed line position being controlled by the sliders.

As shown by plot 2560, selected two points are determined and are output in the table 2570. A user can see two variants of VRP settings to choose from; and can make a choice, such as based on experience and knowledge of the field.

The selected variant of settings can then be submitted to the VRP algorithm which is initiated and executed. The VRP algorithm can then generate optimal routes for each technician. This information can be utilized in various ways, including corresponding route information being provided to equipment of each of the technicians or provided to a monitoring system for tracking whereabouts of technicians.

In one or more embodiments, multi-objective optimization generates multiple Pareto optimal solutions, where the final selection can be made by a user manually. Plot 2550 shows all calculated mpd and jpt values. Mpd in this example has a range from 3.8 to 4.8 miles, which means that algorithm tuning can improve mpd by 10-20%. Jpt has a range from 2.63 to 2.85 jobs per technician, which can be improved by 5-10%.

Points 2565 on the plot 2560 represent the Pareto frontier. The other points are dominated by points 2565. It is not necessary to consider one of the other points as a candidate for final solution because for any other point we can find a dominant point 2565 which is better by both objectives simultaneously, which is why the plot 2560 outputs only Pareto optimal points in this example.

Manual Tuning of the VRP algorithm can be a useful option for the cases when users want to have more information and better control over the VRP tuning process. However, if there are hundreds of geo-locations then the manual approach might be applied just to a few of them, and for all others an automatic approach would be used.

In one or more embodiments, single-objective constrained optimization and automatic tuning of an algorithm (e.g., the VRP algorithm) can be performed. Design of Experiments and model building process can be the same for manual and automatic tuning the VRP algorithm.

Multi-objective optimization naturally fits a VRP algorithm tuning process because it is required to improve several KPIs (several objectives). However, it generates multiple Pareto optimal solutions, and a user would manually select one of them to be used as settings to the VRP algorithm. In order to automate choosing of an optimal solution, a task formulation can be employed which finds a single solution.

The multi-objective optimization task of equation 2 can be transformed into a single-objective constrained optimization task (6):

$$C = {C}^{*} \qquad ( 6 )$$

$${min}_{x ∈ X} {f}_{1} ( C , X )$$

$$\begin{matrix}{f}_{2} ( C , X ) < {f}_{2}^{*} \\ {f}_{3} ( C , X ) < {f}_{3}^{*}\end{matrix}$$

$$…$$

$${f}_{n} ( C , X ) < {f}_{n}^{*}$$

where: C* is a vector of constant work load parameters for a VRP task; ƒ₁(C, X) is main objective function, which needs to be minimized; and {ƒ₂(C, X), ƒ₃(C, X), . . . , ƒₙ(C, X)} are functions constrained by constant values ƒᵢ*, i=2, . . . , n.

In one embodiment, an automated mode of optimization can completely exclude user actions and decisions. For example, all necessary data can be automatically queried from external data sources such as databases, configuration files, etc., and decisions can be made algorithmically. In one embodiment, regression models for KPIs can be or are already built; and tuning of the VRP algorithm is performed for the current date and particular geo location associated with a location_id value.

In one embodiment, a sequence of steps is as follows:
Assign location_id value taken from an external data source;
Load totalTech and totalJobs values for current date and location_id from an external data source;
Load KPI regression models for location_id from an external data source;
Load ranges for tuned parameters X from an external data source;
Load constraints ƒᵢ*, i=2, . . . , n from an external data source;
Generate N UDS points within loaded ranges, and collect all the points in a table T;
Create two additional columns in the table T with constant values totalTech and totalJobs;
Apply the KPI regression models to the table T, and calculate KPI values;
Apply constraints ƒᵢ*, i=2, . . . , n to the KPI columns in the table T, and filter out all the points that infringed the constraints;
Find in the table T optimal point with minimum value of main objective ƒ₁(C, X);
Read tuned parameters values X from the optimal point, and substitute them into the VRP algorithm;
Launch the VRP algorithm;
Obtain optimal routes for each technician.

Referring to FIG. 2G, plot 260 illustrates the optimization result. As an example, assume that jpt was the main objective, and mpd was a constrained function with constraint value 3.95—see dash line 2620. The constraint that was utilized split all of the generated UDS points into two subsets: (a) the points satisfying the constraint (darker markers 2610), and (b) the points not satisfying the constraint (lighter markers 2615)—see “apply constraints” step in the above algorithm.

The best point among the darker points 2610 can be identified. Since the main objective is jpt, and it needs to be maximized, the optimal point 2650 is at the very top. Table 2640 shows all coordinates of the optimal point; the values in the frame 2645 represent optimal tuning parameters, which can be submitted to the VRP algorithm before computing optimal routes for technicians in the location associated with given location_id.

The above algorithm is explained using data from the example described with respect to manual tuning. However, the algorithms described herein can be applied to high-dimensional tasks with many categorical and numeric tuned parameters, with several KPI functions, and/or with multiple supply-demand parameters.

A large number of companies use computational algorithms to solve scientific and business problems, and optimal design problems. Typically, such algorithms have several parameters which should be tuned. Use of the exemplary embodiments described herein creates improvements in quality and efficiency of such algorithms.

Tuning of hyperparameters for model building algorithms can be performed, which allows maximizing a model's predictive accuracy. Existing hyperparameter tuning such as a grid search, tend not to be efficient. Use of the exemplary embodiments described herein provides improvement in a model's predictive accuracy, and can save computational time because a grid search can be a time-consuming type of search.

In one or more embodiments, model-based manual and automatic tuning of VRP algorithms and other types of algorithms is provided with respect to KPI functions reflecting business efficiency. This is different from other processes where a default set of the algorithm parameters is used regardless of the supply-demand and geo-location parameters. One or more of the exemplary embodiments also can be used to avoid needing experts to tune the algorithms manually based on their own experience and field knowledge, since the availability of such experts is limited, and the quality of such manual tuning is lower than the embodiments described herein.

While for purposes of simplicity of explanation, the respective processes are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

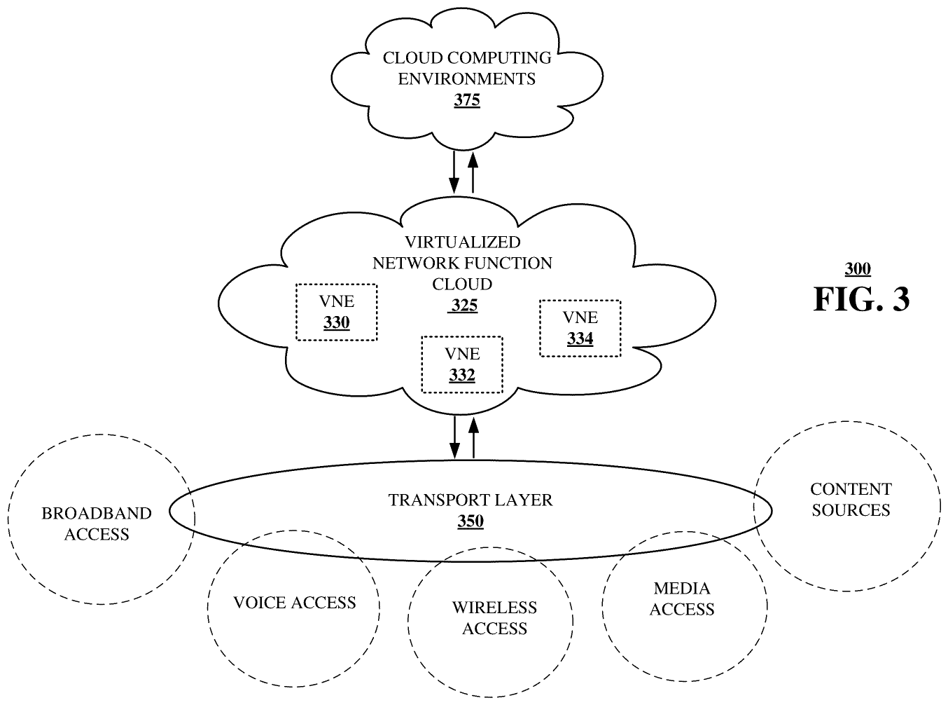

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100. For example, virtualized communication network 300 can facilitate in whole or in part implementing a model-based technique, which can include one or more of: (a) design of experiment (DOE) as a uniformly distributed sequence over tuned parameters' space; (b) running VPR algorithm multiple times according to the DOE plan and calculating all KPIs which need to be improved; (c) building a regression model for each KPI; and (d) optimizing the model to determine optimally tuned VPR algorithm parameters for any given use case.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements that may be used in network 125 of FIG. 1. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element, such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access, wireless access, voice access, media access and/or access to content sources for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

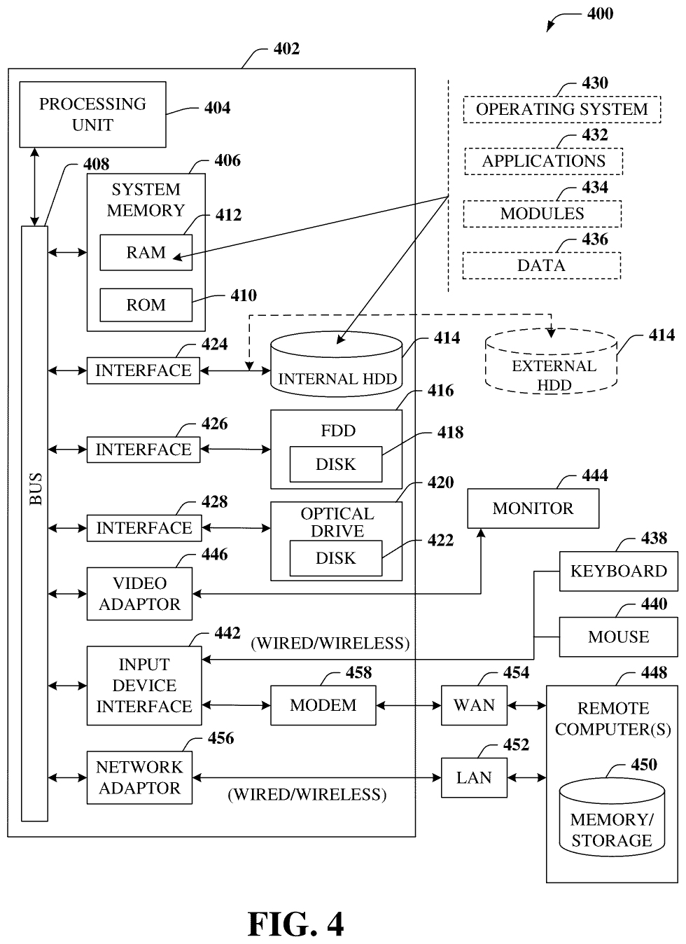

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements, access terminal, base station or access point, switching device, media terminal, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part implementing a model-based technique, which can include one or more of: (a) design of experiment (DOE) as a uniformly distributed sequence over tuned parameters' space; (b) running VPR algorithm multiple times according to the DOE plan and calculating all KPIs which need to be improved; (c) building a regression model for each KPI; and (d) optimizing the model to determine optimally tuned VPR algorithm parameters for any given use case.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

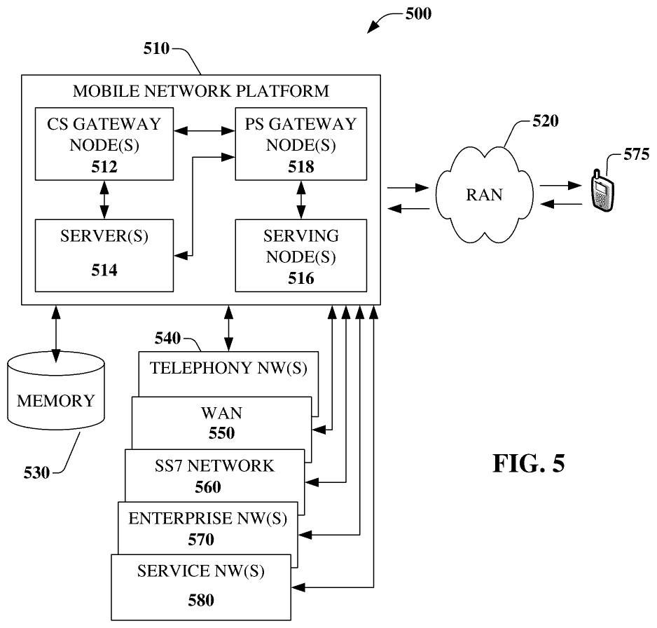

Turning now to FIG. 5, an embodiment 500 of a mobile network platform 510 is shown that is an example of network elements, and/or VNEs 330, 332, 334, etc. For example, platform 510 can facilitate in whole or in part implementing a model-based technique, which can include one or more of: (a) design of experiment (DOE) as a uniformly distributed sequence over tuned parameters' space; (b) running VPR algorithm multiple times according to the DOE plan and calculating all KPIs which need to be improved; (c) building a regression model for each KPI; and (d) optimizing the model to determine optimally tuned VPR algorithm parameters for any given use case. In one or more embodiments, the mobile network platform 510 can generate and receive signals transmitted and received by base stations or access points such as base station or access point. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

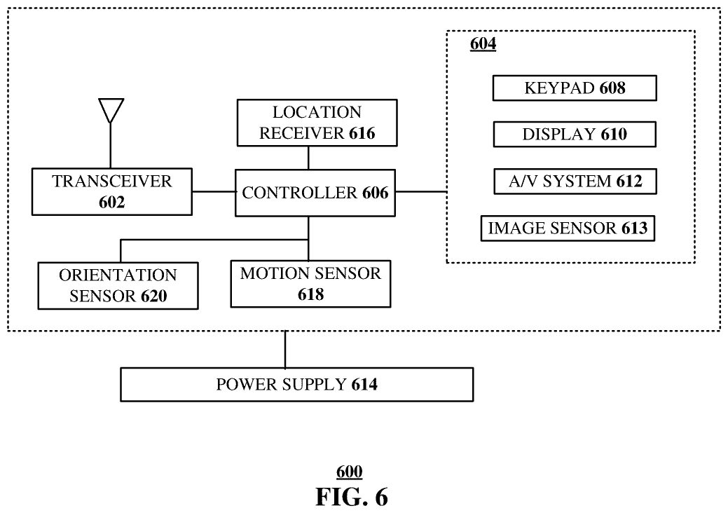

Turning now to FIG. 6, an illustrative embodiment of a communication device 600 is shown. The communication device 600 can serve as an illustrative embodiment of devices such as data terminals, mobile devices, vehicles, display devices or other client devices for communication via communications network 125. For example, computing device 600 can facilitate in whole or in part implementing a model-based technique, which can include one or more of: (a) design of experiment (DOE) as a uniformly distributed sequence over tuned parameters' space; (b) running VPR algorithm multiple times according to the DOE plan and calculating all KPIs which need to be improved; (c) building a regression model for each KPI; and (d) optimizing the model to determine optimally tuned VPR algorithm parameters for any given use case.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having GUI elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method comprising:
designing of a numerical experiment, by a processing system including a processor, for tuned parameters and external parameters for a parametrized algorithm;
calculating, by the processing system, Key Performance Indicators (KPIs) for the parametrized algorithm for each combination of the tuned parameters and the external parameters;
generating, by the processing system, regression models based on the tuned parameters and the external parameters for each of the KPIs;
optimizing, by the processing system, the regression models with constant external parameters values and determining optimal values of the tuned parameters; and
executing, by the processing system, the parametrized algorithm with the optimal values of the tuned parameters.

2. The method of claim 1, wherein the optimizing of the regression models is performed by multi-objective optimization utilizing each of the KPIs as an objective function, and further comprising receiving user input of a selection from among multiple Pareto optimal solutions according to the multi-objective optimization.

3. The method of claim 2, wherein the multi-objective optimization of the regression models is based on a Monte Carlo algorithm.

4. The method of claim 2, wherein the multi-objective optimization of the regression models is based on an evolutionary algorithm.

5. The method of claim 1, wherein the optimizing of the regression models is performed by constrained single-objective optimization, wherein one of the KPIs is used as a main objective, wherein other KPIs are used as constraints, and wherein a single optimal solution is selected automatically.

6. The method of claim 5, wherein the constrained single-objective optimization is performed based on a Monte Carlo algorithm.

7. The method of claim 1, wherein the designing of a numerical experiment is based on a uniformly distributed sequence.

8. The method of claim 7, wherein the uniformly distributed sequence is a sequence of random points.

9. The method of claim 7, wherein the uniformly distributed sequence is a sequence of Sobol points.

10. A device, comprising:
a processing system including a processor; and
a memory that stores executable instructions that, when executed by the processing system, facilitate performance of operations, the operations comprising:
obtaining values, constraints and tuned parameters from an external source that are associated with an algorithm;
access Key Performance Indicators (KPI) regression models associated with at least one of the parameters;
generate Uniformly Distributed Sequence (UDS) points within a range for the tuned parameters;
calculate KPI values utilizing the KPI regression models and the UDS points;
filter the KPI values based on the constraints to generate filtered KPI values;
select particular tuned parameters from a point from among the filtered KPI values; and
execute the algorithm utilizing the particular tuned parameters.

11. The device of claim 10, wherein the algorithm is a vehicle routing problem algorithm and wherein the operations further comprise providing routes determined by the vehicle routing problem algorithm to equipment of one or more technicians.

12. The device of claim 11, wherein the values include location information, technician information and job information.

13. The device of claim 11, wherein the constraints include miles per dispatch.

14. The device of claim 11, wherein the particular tuned parameters are selected according to jobs per technician.

15. The device of claim 11, wherein the UDS points within the range for the tuned parameters is based on a Sobol sequence.

16. A non-transitory machine-readable medium, comprising executable instructions that, when executed by a processing system including a processor, facilitate performance of operations, the operations comprising:
providing a Graphical User Interface (GUI) at a display that includes icons for selecting values that are associated with a tunable algorithm and for selecting one or more constraints for one or more objectives;
executing a Monte Carlo algorithm based on the values and responsive to movement of one or more of the icons resulting in generated values;
applying a Pareto filter to the generated values resulting in filtered values;
applying the one or more constraints for the one or more objectives to the filtered values resulting in tuned values; and
executing the tunable algorithm utilizing the tuned values.

17. The non-transitory machine-readable medium of claim 16, wherein the tunable algorithm is a vehicle routing problem algorithm and wherein the operations further comprise providing routes determined by the vehicle routing problem algorithm to equipment of one or more technicians.

18. The non-transitory machine-readable medium of claim 17, wherein the values include at least one of location information, technician information or job information.

19. The non-transitory machine-readable medium of claim 17, wherein the one or more constraints includes miles per dispatch.

20. The non-transitory machine-readable medium of claim 17, wherein the one or more constraints includes jobs per technician.
